(19) United States
(12) Patent Application Publication
(10) Pub. No.: US 2003/0022555 A1
(43) Pub. Date: Jan. 30, 2003

(54) Ground plane shielding array

(75) Inventors: Brian R. Vicich, Louisville, KY (US); Joshua L. Ferry, Georgetown, IN (US); John K. Hynes, Prospect, KY (US)

Correspondence Address: Woodard, Emhardt, Naughton, Moriarty and McNett, Bank One Center/Tower, Suite 3700, 111 Monument Circle, Indianapolis, IN, 46204-5137, US

(73) Assignee: Samtec, Inc.

(21) Appl. No.: 09/821,938

(22) Filed: Mar. 30, 2001

(51) Int. Cl. H01R 13/648

(52) U.S. Cl. 439/608

(57) ABSTRACT

An electrical connector for connecting two independent electrical devices, such as printed circuit boards, in electrical communication, including a male portion electrically connectable to a first device and a female portion electrically connectable to a second device. The male portion further includes an electrically insulated base portion having an array of electrically grounded L-shaped shield plates extending therefrom. The shield plates are oriented to define a plurality of substantially rectangular substantially electrically isolated regions. At least one elongated electrical contact extends from the male base portion through each of the substantially rectangular substantially electrically isolated regions. The electrical connector also includes a female portion adapted to interlockingly engage the male portion. The female portion includes an insulated base with an array of substantially rectangular substantially electrically insulated receptors formed therein and adapted to receive the array of shield plates extending from the male portion. The female portion also includes an array of pin receptors adapted to receive the pins extending from the male portion when the male and female portions are interconnected.

### TECHNICAL FIELD OF THE INVENTION

The present invention relates generally to electrical connectors and, more particularly, to an array of L-shaped ground planes positioned to provide electrical shielding for individual electrical contacts or connections.

### BACKGROUND OF THE INVENTION

Electrical connectors are used to place electrical devices, such as printed circuit boards, in electrical communication with one another. Typically, an electrical connector includes a set of electrical contacts that are adapted to receive a first set of pins from the first device to be coupled. The set of contacts extends from the electrical connector and terminates in a second set of pins that connect to the second device to be coupled, placing the two devices in electrical communication with each other through the electrical connector.

The current trend towards miniaturization of electrical devices allows for smaller, faster devices with increased memory and decreased cost, but also means a greater number of electrical connections have to be made in a smaller volume to accommodate communications between devices. As the number of electrical connections in a given volume increases, so does potential for radio frequency (RF) noise interference, or crosstalk, between the connections.

One method of providing RF shielding for an electrical connector is discussed in U.S. Pat. No. 5,620,340. The '340 patent discloses the use of arrays of square-wave shaped shield plates to form rectangular boxes around groups of electrical contact pins to shield them from other, neighboring pins. While the '340 shielding configuration reduces crosstalk, it is difficult and expensive to mass produce connectors using the square-wave shaped shielding pieces, since it is difficult to maintain proper alignment of a large number shielding pieces having such a complex shape.

There is therefore a need for an electrical connector design that provides RF shielding of electrical pins while remaining simple and inexpensive to produce. The present invention is directed towards meeting this need.

### SUMMARY OF THE INVENTION

The present invention relates to an electrical connector for connecting two independent electrical devices, such as printed circuit boards, in electrical communication. The electrical connector includes a male portion electrically connectable to a first device and a female portion electrically connectable to a second device. The male portion further includes an electrically insulated base portion having an array of electrically grounded L-shaped shield plates extending therefrom. The shield plates are oriented to define a plurality of substantially rectangular (although non-continuous) substantially electrically isolated regions. At least one elongated electrical contact extends from the male base portion through each of the substantially rectangular electrically isolated regions.

The electrical connector also includes a female portion adapted to interlockingly engage the male portion. The female portion includes an insulated base with an array of substantially rectangular electrically insulated receptors formed therein and adapted to receive the array of shield plates extending from the male portion. The female portion also includes an array of pin receptors adapted to receive the pins extending from the male portion when the male and female portions are interconnected. The pin receptors are electrically connected to the second device, such that, when the male and female portions are joined to form an electrical connector, the first device is in electrical communication with the second device through the appropriate pins and receptors of the electrical connector. Clarity of communication is achieved by electrically isolating small sets of pins with the L-shaped shield members to form electromagnetically shielded zones around each small set of pins.

One object of the present invention is to provide an improved electrical connector device. Related objects and advantages of the present invention will be apparent from the following description.

### BRIEF DESCRIPTION OF THE DRAWINGS

FIG. 1 is a perspective view of the male and female portions of a first embodiment electrical connector of the present invention.

FIG. 2 is an enlarged partial perspective view of the male portion of FIG. 1.

FIG. 3 is an enlarged partial perspective view of the female portion of FIG. 1.

FIG. 4 is an enlarged partial perspective view of the reverse side of FIG. 2.

FIG. 5 is an enlarged partial perspective view of the reverse side of FIG. 3.

### DETAILED DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

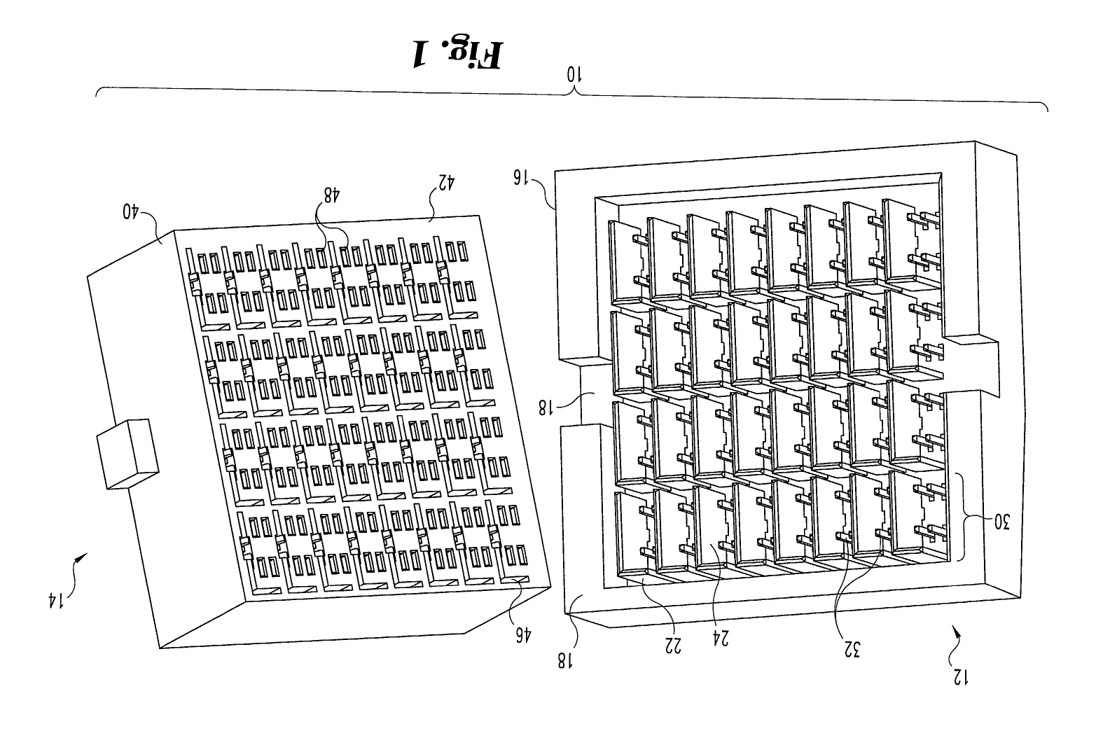

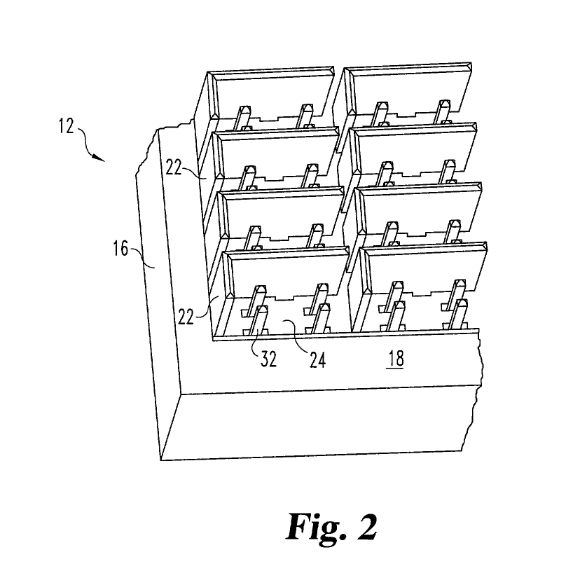

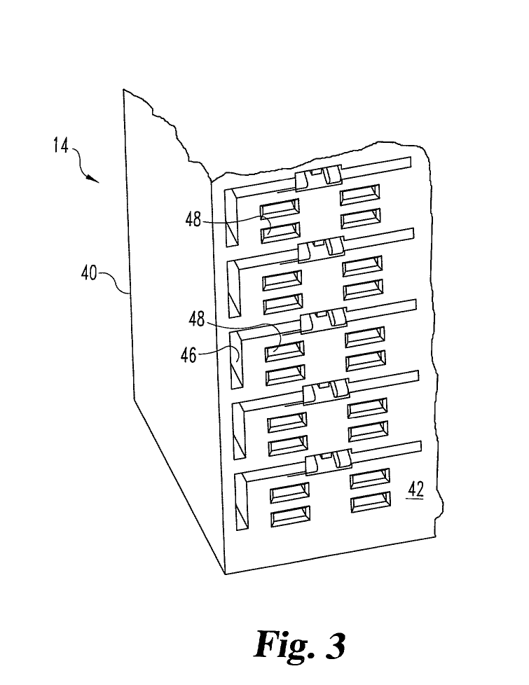

FIGS. 1-5 illustrate a first embodiment of the present invention, an electrical connector 10 for joining two electrical devices, such as printed circuit boards, each having plural sets of electrical contacts, wherein each set of contacts is desired to be isolated from electromagnetic interference, such as radio frequency (RF) electrical noise potentially generated by the other sets of electrical contacts and/or ambient RF interference generated outside the electrical connector 10. Referring to FIGS. 1-3, the electrical connector 10 includes a male portion 12 and a female portion 14. The female portion 14 is adapted to matingly interlockingly receive the male portion 12 to form the complete electrical connector 10.

The male portion 12 includes an insulated male housing 16 having two major sides, an inner face 18 and an outer face 20. An array of angled shield plate members 22 extends away from the inner face 18 to define a plurality of RF-shielded or electrically isolated regions 24. The shield plate members 22 can be placed into electrical communication with a ground potential, either individually or through electrical interconnection between one or more electrically grounded members 22.

Each angled shield plate member 22 is defined by a first and second planar electrically conducting shield member joined at an angle. Preferably, the angled shield plate members 22 are all substantially identically shaped. Also preferably, the joint angle is a right angle. More preferably, the shield plate members 22 have a short base member and an elongated side member (in other words, the shield plate members 22 are preferably L-shaped).

The L-shaped shield plate members 22 are preferably organized to form a substantially orthogonal array, such that adjacent L-shaped shield members 22 define an array of rectangular-based parallelepiped-shaped electrically isolated regions 24. In other words, the L-shaped shield members 22 are positioned upon the inner face 18 to form rectangular “boxes”, such that each “box” has two parallel elongated sides and two parallel base sides. The bottom of the “box” is provided by the inner face 18, and the top is provided by the female portion 14 when the male and female portions 12, 14 are interconnected.

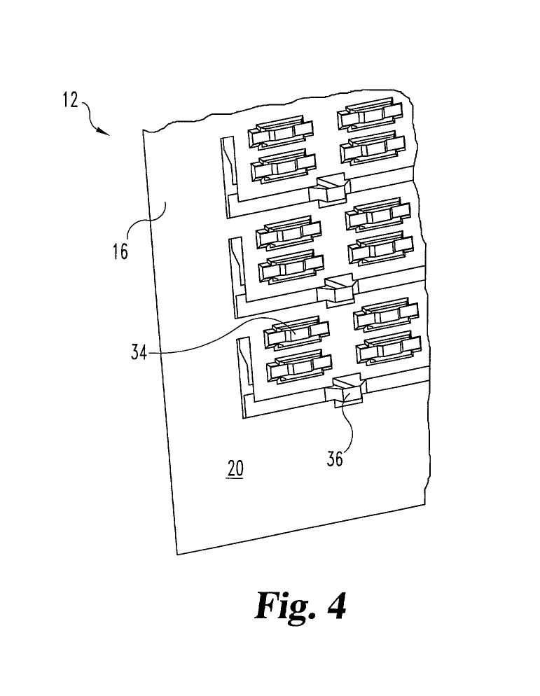

A set of one or more connection pins 30 extends outwardly from the inner face 18 through each electrically isolated region 24. Each pin set 30 preferably includes four pins 32 spaced apart from each other. Each pin 32 extends through the male portion 12 to terminate in a pin base 34 on the reverse side or outer face 20 of the male portion 12 (see FIG. 4). Likewise, the L-shaped shield plate members 22 extend through the male portion 12 and terminate in respective shield plate bases 36 formed on the outer face 20. The pin and shield plate member bases 34, 36 may be connected in electrical communication to pre-selected electrically conducting pads on a compatible circuit board (not shown) by any convenient electrical connection means, such as soldering. In this embodiment, the bases 34, 36 are recessed to readily receive solder masses, such as solder balls, to facilitate the electrical connection to a compatible circuit board or the like.

Referring back to FIGS. 1, 3 and 5, the female portion 14 includes an electrically insulating female housing 40. The female portion has an outer face 42 into which an array of shield member-receiving slots 46 are formed, and an inner face 44. The shield plate member-receiving slots 46 are sized, shaped, and spaced in the female housing 40 such that when the male and female housings 16, 40 are interconnected, each shield member 22 is matingly received into a respective shield plate member-receiving slot 46. The shield plate member-receiving slots 46 are preferably electrically conducting, such that a shield member 22 matingly received thereinto may be electrically connected to a ground potential through the shield plate member-receiving slot 46. More preferably, the shield plate members 22 are redundantly grounded both through the shield plate bases 36 in the male portion 12 and the shield plate member-receiving slots 46 in the female portion 14 to ensure proper grounding of the so-formed electrically isolated regions 24.

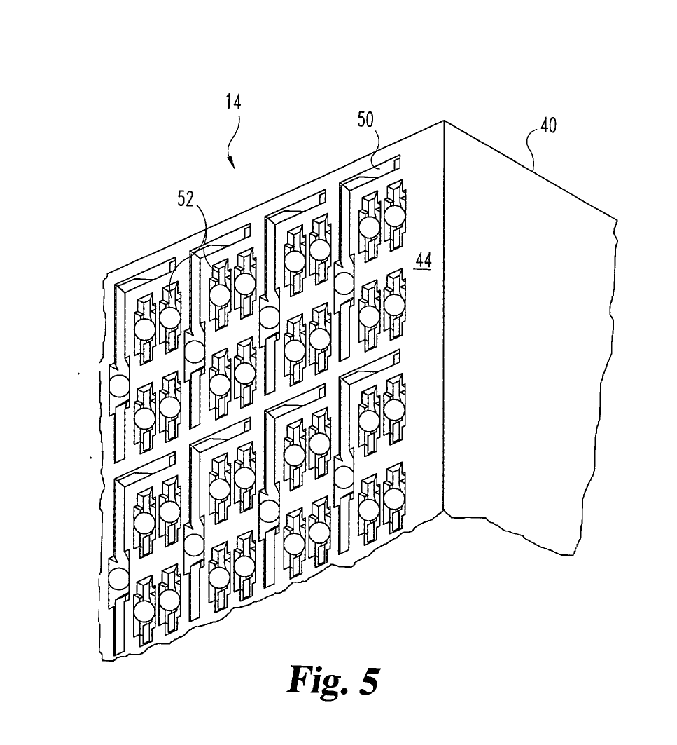

The female portion 14 further includes arrays of pin receiving slots 48 formed in the inner face 44. The pin receiving slots 48 are likewise sized, shaped, and spaced to matingly receive the arrays of pins 30 extending from the inner face 18 of the male housing 16 when the male and female housings 16, 40 are interconnected. Each pin receiving slot 48 is electrically conducting to produce an electrically communicative connection with a pin 32 matingly received therein. The shield plate member-receiving slots 46 and pin receiving slots 48 terminate in electrically conducting shield plate member-receiving slot bases 50 and pin receiving slot bases 52 respectively formed on the outer face 42 of the female housing 40 (see FIG. 5). The shield plate member-receiving slot bases 50 and pin receiving slot bases 52 are preferably recessed to readily accommodate electrical connection media, such as solder balls, for the electrical connection of the outer face 42 of the female portion 14 to a compatible electrical device, such as a circuit board (not shown).

In operation, the male and female portions 12, 14 are electrically connected to respective compatible electrical devices, such as printed circuit boards, desired to be engaged in electrical communication with one another. The male and female portions 12, 14 may be connected to the respective electrical devices by any convenient means, such as soldering. It is noted that electric connections are made such that predetermined pins and pin receptors 32, 48 are electrically connected to the respective devices such that, when the male and female portions 12, 14 are electrically interconnected, the resulting electrical connector 10 places the two devices in proper electrical communication, as desired. The male and female portions 12, 14 are preferably held mechanically connected through an interference fit between the shield members 22 and pins 32 extending from the male portion 12 into the respective receiving slots 46, 48 of the female portion 14. However, standard mechanical connectors, such as clamps, threaded screws and recesses, nuts and bolts, or the like may be used to hold the electrical connector 10 together if desired.

The insulated male and female housing portions 16, 40 may be formed from any convenient electrically non-conducting material, such as plastic or ceramic. The electrically conducting shield members 22, pins 32, bases 34, 36, 50, 52, and slots 46, 48 may be each formed from any convenient electrically conducting material, such as steel, copper, silver, gold, platinum or the like. While the electrical conductors are preferably metallic, ceramic or polymer-based conductors are also contemplated.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are to be desired to be protected.

What is claimed is:

1. An electrical connector, comprising:
a male portion further comprising:
an electrically insulated male base portion;
an array of electrically grounded L-shaped shield plates extending from the male base portion and oriented to define a plurality of substantially rectangular substantially electrically isolated regions; and
at least one elongated electrical contact extending from the male base portion through each of the substantially rectangular substantially electrically isolated regions; and
a female portion adapted to interlockingly engage the male portion and further comprising:
an electrically insulated female base portion; and
an array of substantially rectangular substantially electrically insulated receptors formed in the female base portion;
wherein each receptor includes an L-shaped slot extending partially therethrough and at least one elongated recess formed therein;
wherein each receptor is adapted to receive a shield plates and at least one elongated electrical contact; and
wherein the array of substantially rectangular substantially electrically insulated shield plate receptors is adapted to engagingly receive the array of electrically grounded L-shaped shield plates and the array of elongated electrical contacts.

2. The electrical connector of claim 1 wherein each substantially rectangular substantially electrically isolated region electrically isolates a plurality of elongated electrical contacts.

3. The electrical connector of claim 1 wherein each substantially rectangular substantially electrically isolated region isolates four elongated electrical contacts.

4. The electrical connector of claim 1 wherein each substantially rectangular substantially electrically isolated region is formed by at least two adjacent L-shaped shield plates.

5. The electrical connector of claim 1 wherein each substantially rectangular substantially electrically isolated region is formed by at least three adjacent L-shaped shield plates.

6. The electrical connector of claim 1 wherein each elongated recess is adapted to receive an elongated electrical contact in electrical communication therewith.

7. An electrically shielded electrical connector, comprising:
an electrically insulated base;
an array of angled shield plates connected to the base and oriented to define a plurality of substantially electrically isolated regions; and
at least one elongated electrical contact extending through each substantially electrically isolated region;
wherein each angled shield plate includes a single angled bend;
wherein each angled shield plate is electrically connected to at least one other shield plate; and
wherein at least one angled shield plate is electrically connected to a ground potential.

8. The electrically shielded electrical connector of claim 7 wherein each elongated electrical connector extends completely through the base portion.

9. The electrically shielded electrical connector of claim 7 wherein the angle of each angled shield plate is substantially right.

10. The electrically shielded electrical connector of claim 9 wherein each angled shield plate is substantially L-shaped.

11. The electrically shielded electrical connector of claim 7 further comprising:
a housing adapted to lockingly engage the electrically insulated base and further comprising:
an electrically insulated cover portion; and
an array of electrically insulated shield plate receptors formed in the cover portion;
wherein each shield plate receptor is defined by an angled slot extending partially therethrough; and
wherein each shield plate receptor is adapted to receive an angled shield plate.

12. The shielded electrical connector of claim 7 wherein each substantially electrically isolated region comprises at least two spaced angled shield plates.

13. The shielded electrical connector of claim 7 wherein each substantially electrically isolated region comprises at least two angled shield plates in electrical communication with each other.

14. A shielded electrical connector, comprising:
an insulated base;
a plurality of L-shaped shield plates connected to the base; and
a plurality of electrical contacts extending through the base;
wherein the plurality of L-shaped shield plates are positioned to form a plurality of substantially electrically isolated regions;
wherein each L-shaped shield plate is in electrical communication with a ground potential; and
wherein at least one electrical contact extends through each substantially electrically isolated region.

15. The shielded electrical connector of claim 14 wherein each substantially electrically isolated region is a substantially right rectangular parallelepiped.

16. The shielded electrical connector of claim 14 further comprising a housing portion adapted to lockingly engage the base.

17. The shielded electrical connector of claim 16 wherein the housing portion includes an electrically insulated cover portion, a plurality of L-shaped slots formed in the cover portion, and a plurality of electrically conducting recesses formed in the cover portion; and wherein each slot is adapted to engagingly receive having an L-shaped shield plate, and wherein each electrically conducting recess is adapted to receive an electrical contact in electrical communication therewith.

18. The shielded electrical connector of claim 17 wherein each slot is adapted to receive a respective L-shaped shield; wherein each L-shaped shield is adapted to be received in a respective slot; wherein each recess is adapted to receive an electrical contact; and wherein each electrical contact is adapted to be received in a recess.

19. A connector for facilitating communications between electrical devices, comprising:
an electrically insulating base;
groupings of contact-receiving apertures formed through the base; and
a plurality of electrically grounded L-shaped shield plates connected to the base;
wherein the L-shaped shield plates are positioned to form crosstalk barriers around the respective groupings of contact-receiving apertures; and
wherein the crosstalk barriers substantially block the transmission of radio frequency electromagnetic radiation.

20. The connector of claim 19 further including a grouping of elongated electrical contacts extending through at least one respective grouping of contact-receiving apertures into at least one respective crosstalk barrier and wherein the at least one crosstalk barrier substantially isolates the at least one respective grouping of electrical contacts from outside-generated radio frequency electromagnetic radiation.

21. The connector of claim 20 further comprising a cover portion having slots and recesses formed therein for receiving the respective L-shaped shield members and elongated electrical contacts and wherein the cover portion is adapted to be matingly connected to the base portion.

22. A method for producing an electrical connector having an array of electrically isolated regions, comprising the steps of:
a) providing electrically insulating interlockable male and female base portions, each having inner and outer faces;
b) providing an array of L-shaped grounded shield members connected to the inner face of the male base portion;
c) positioning the array of L-shaped grounded shield members to define a plurality of substantially rectangular based parallelepipeds;
d) extending at least one elongated electrical connector through the outer face of the male base into each substantially rectangular based parallelepiped;
e) providing a plurality of slotted receptors in the female base portion, wherein each slotted receptor is sized and positioned to receive a respective L-shaped grounded shield member;
f) forming a plurality of recesses in the female base portion, wherein each recess is sized and positioned to receive a respective elongated electrical connector; and
g) interlocking the male and female base portions.
